(19) United States
(12) Patent Application Publication
(10) Pub. No.: US 2012/0278134 A1
(43) Pub. Date: Nov. 1, 2012

(54) SYSTEM AND METHOD FOR OPERATIONAL AND BEHAVIORAL BUSINESS INTELLIGENCE

(75) Inventors: Francis A. Papay, Westlake, OH (US); Byron C. Clayton, Hudson, OH (US); Paul V. Dorsch, Warren, OH (US); Mark A. Roshon, Chagrin Falls, OH (US)

(73) Assignee: THE CLEVELAND CLINIC FOUNDATION

(21) Appl. No.: 13/410,397

(22) Filed: Mar. 2, 2012

Related U.S. Application Data
(60) Provisional application No. 61/448,838, filed on Mar. 3, 2011.

(51) Int. Cl. G06Q 10/06

(52) U.S. Cl. 705/7.37

(57) ABSTRACT

A non-transitory computer readable medium can be programmed to provide an operational-behavioral business intelligence system that includes an idea manager programmed to manage ideas submitted by a user. Each idea can be stored in a knowledgebase and be capable of validation and conversion into an experiment. An experiment manager can be programmed to manage each experiment, including design, execution and analysis thereof. Each experiment can employ a performance indicator to provide a measure of performance based on behavior probe data captured via a behavior probe, the measure of performance being stored as experiment data for each respective experiment. A continuous positive reinforcement (CPR) engine can generate CPR data to provide substantially continuous reinforcement to users based on the data stored in the knowledgebase to drive business processes innovation.

### CROSS-REFERENCE TO RELATED APPLICATION

This application claims the benefit of U.S. Provisional Patent Application No. 61/448,838 filed on Mar. 3, 2011, and entitled SYSTEM AND METHOD FOR OPERATIONAL AND BEHAVIORAL BUSINESS INTELLIGENCE, which is incorporated herein by reference in its entirety.

### TECHNICAL FIELD

This disclosure relates to a system and method for behavioral modification that encourages user engagement through positive reinforcement.

### BACKGROUND

In order to enhance the quality of service, businesses and organizations often employ various mechanisms for tracking customer satisfaction. For example, this can involve the use of surveys to solicit information about services received by a given customer. Businesses and enterprises also can use utilize various business intelligence systems to track various facets of the business and calculate various indications of performance based on objective and subjective criteria that can be measured or monitored. In other examples, consultants can be utilized to monitor a portion of a given business and work with management to implement various changes in an effort to improve performance and overall satisfaction for this part of the business. However, in each of these examples, it is difficult to maintain a cycle of continuous improvement over time.

### SUMMARY

This disclosure relates to a system and method for behavioral modification that encourages user engagement through positive reinforcement.

In one example, a non-transitory computer readable medium can be programmed to provide an operational-behavioral business intelligence system that includes an idea manager programmed to manage ideas submitted by a user. Each idea can be stored in a knowledgebase and be capable of validation and conversion into an experiment. An experiment manager can be programmed to manage each experiment, including design, execution and analysis thereof. Each experiment can employ a performance indicator to provide a measure of performance based on behavior probe data captured via a behavior probe, the measure of performance being stored as experiment data for each respective experiment. A continuous positive reinforcement (CPR) engine can generate CPR data to provide substantially continuous reinforcement to users based on the data stored in the knowledgebase to drive business processes innovation.

As another example, a method to provide operational-behavioral business intelligence system can include receiving a tip in response to a user input and storing information related to the tip as tip data in memory. An idea for a process improvement can be generated in response to a user input that includes instructions to convert a given tip into the idea or to create a new idea. The method can also include storing idea data in the memory related to the generated idea. An experiment can be created to ascertain effectiveness of a selected idea in response to a user input. The experiment can include at least one performance indicator operative to provide a measure of a behavioral parameter. Probe data can be captured via a behavior probe, the probe data providing a measure of the at least one performance indicator for the experiment. The probe data can be stored in the memory as experiment data for the respective experiment. The method can also include providing a user interface to provide an indication of each user's engagement with the system in relation to at least one of the tips, the ideas and other interactions with the system.

### BRIEF DESCRIPTION OF THE DRAWINGS

FIG. 1 depicts an example of a system for operational-behavioral business intelligence.

FIG. 2 depicts an example of a KPI tree demonstrating interrelationships among various KPIs.

FIG. 3 is a flow diagram depicting an example of an experiment process.

FIG. 4 is a flow diagram depicting an example of a method for creating an experiment from an idea.

FIG. 5 depicts front and back views of an example probe device that can be utilized for inputting behavioral data.

FIG. 6 depicts an example of a map demonstrating geospatial locations for tips that have been entered into the system.

FIGS. 7 and 8 depict geospatial maps demonstrating an example of an experiment that can be implemented.

FIG. 9 depicts a graphical user interface demonstrating an example of a dashboard.

FIG. 10 depicts a GUI demonstrating an example of details for an experiment that is being implemented.

FIG. 11 depicts an example of a GUI demonstrating entry of a new tip.

FIG. 12 depicts an example of a message that can be sent in response to a tip from an identified user.

FIG. 13 depicts an example GUI demonstrating a set of recent tips.

FIG. 14 depicts an example GUI demonstrating tips on a location map.

FIG. 15 depicts an example GUI demonstrating an idea that is received via a voice mail interface.

FIG. 16 depicts an example of a GUI illustrating information about ideas that have been entered into the system.

FIG. 17 depicts an example of a GUI demonstrating for details of an idea and related comments.

FIG. 18 depicts an example of a GUI for creating a new idea.

FIG. 19 depicts of an example of a GUI that can be utilized for managing ideas.

FIG. 20 depicts an example of a GUI demonstrating active ideas and related status information.

FIG. 21 depicts an example of a GUI that can be employed to edit an experiment.

FIG. 22 depicts an example of a GUI demonstrating a report of staff engagement.

FIG. 23 depicts an example of a GUI demonstrating a report of impact on a group or team.

FIG. 24 depicts an example a GUI demonstrating a report of user contributions.

### DETAILED DESCRIPTION

The invention relates generally to a system and method for operational-behavioral business intelligence. Operational-behavioral business intelligence generally corresponds to a linking or combination of business intelligence and business operations process management. The systems and methods disclosed herein can provide a repeatable cycle to manage and implement performance goals that can be used repeatedly to achieve continuous improvements in various facets of a business, including safety, quality of services and customer satisfaction. The approach is not limited to business operations involving employees and management, but also can cross over to clients and customers. The systems and methods disclosed herein combines profits, innovation methods, psychological motivational principles and real-time feedback technology into an integrated operational-behavioral technology. The systems and methods disclosed herein can create a repeatable cycle of success by creating a culture that stimulates and fosters process innovation within an organization at all levels. For the example of a healthcare business, the systems and methods can help improve quality of care being provided by foster innovation and behavioral changes to positively impact the patient experience.

As will be appreciated by those skilled in the art, portions of the invention may be embodied as a method, data processing system, or computer program product. Accordingly, these portions of the present invention may take the form of an entirely hardware embodiment, an entirely machine readable instruction embodiment, or an embodiment combining machine readable instructions and hardware. Furthermore, portions of the invention may be a computer program product on a non-transitory computer-usable storage medium having machine readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by machine-readable instructions. These machine-readable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These machine-readable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

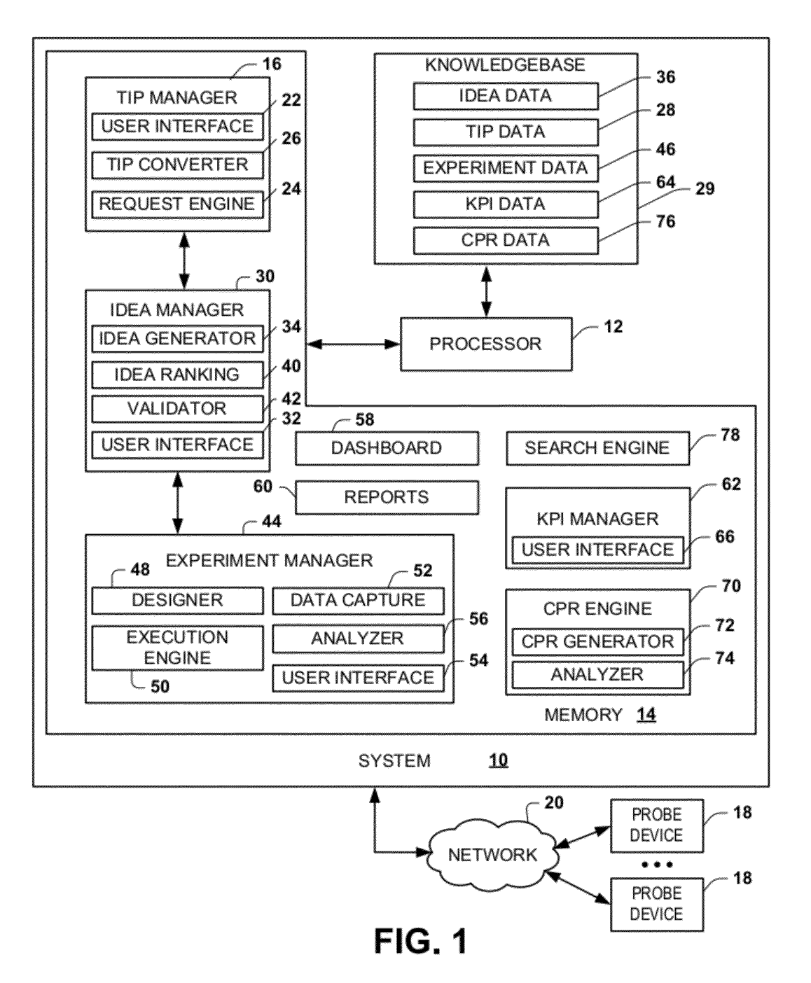

FIG. 1 depicts an example of a system 10 for providing operational-behavioral business intelligence to facilitate process innovation within an organization. The system 10 can be considered an integrated approach that combines process innovation methods, psychological motivational principles and real time feedback technology to provide behavior technology. By way of example, the system and various uses thereof will be described in the context of a healthcare organization. However, the system 10 and related methods disclosed herein are not limited to healthcare. Instead, the systems and methods can be utilized in relation to virtually any type of organization or business enterprise.

In the example of FIG. 1, the system 10 includes a processor 12 and memory 14. The methods and functions for implementing the system 10 can be stored as machine readable instructions in the memory 14 that can be accessed by the processor 12. For example, the memory 14 can comprise physical memory, such as can reside on the processor 12 (e.g., processor memory), random access memory or other physical storage media (e.g., CD-ROM, DVD, flash drive, hard disc drive, etc.) or a combination of different memory devices that can store the machine readable instructions. The data utilized for implementing the systems and methods described herein can also be stored in the memory 14 or in some other arrangement of one or more memory structures that are accessible for use by the system 10.

The system 10 can include a tip manager 16 that can manage tips that are entered into the system 10. As used herein, a tip refers to a precursor form of an idea or an incomplete idea. A tip thus can correspond to a vague observation, a concern or thought about a given situation, location or activity or event. Details about how to improve the situation, location, activity or event for which a tip has been generated may be unspecified. For example, a tip may include an identification of a location, a category of concern (e.g., safety, cost, quality, etc.). A tip may also include an identification of a user who submitted the tip or the tip may be submitted anonymously.

Users may employ various different types of probe devices for interfacing with the system 10, which can also be utilized for entering a tip. In the example of FIG. 1, such devices are demonstrated as generically as devices 18 that can be in communication with the system 10, such as via a network 20. The devices 18 can be implemented, for example, as I/O devices, such as a computer, an appliance, a software application, a transmitter, a transceiver, a mobile device (e.g., a smart phone, tablet computer or the like), an electronic form or survey, or the like. The tips can be entered in response to a user input via the device 18. Alternatively, the device 18 can be configured to automatically provide a corresponding tip or data based on which the tip manager 16 can generate a corresponding tip and store the tip as tip data 28.

The users are not limited to personnel of the business or enterprise, but can also include customers or patients. By way of example, customers can employ probe devices 18 to provide inputs to the system, such as in response to a patient survey (e.g., conducted online via a website or via telephone). The inputs can be collected and aggregated by the tip manager 16 and converted to tips.

The tip manager 16 can include a user interface element 22 that can be programmed to provide a list of tips that have been entered into the system 10. The user interface 22 can also be utilized to select and edit a given tip, such as by the individual user that had initiated the tip or other authorized personnel. The tip manager 16 can also include a request engine 24 that can be utilized to request additional information associated with a given tip. For example, the request engine 24 can send a request via a messaging system (e.g., email) to a user that had initiated the tip to solicit additional information about the tip. The request engine 24 can send the request immediately in response to receiving the tip. Alternatively or additionally, the request engine 24 can periodically request such information periodically from the user.

In one example, a given tip or set of tips can include location data related to the tip, and the location data can be used to organize such tips. The location data can be entered manually with the tip or be acquired automatically via a tracking device, such as corresponding to one or more of the probe devices 18. The tracking device can be implemented as a location aware device, such as including an RFID system, a global positioning system, a cellular telephone or other device that can provide information about a location. Thus, the tip manager 16 can provide an alert or flag for a given tip or set of tips associated with a given location, which can trigger review and further evaluation of the given location based on the tips that have been input for such location.

The tip manager can also include a tip converter 26 that can be utilized to convert a tip into an idea. A general differentiator between an idea and a tip in this context is that an idea includes sufficient details as to be actionable. A purpose for differentiating between tips and ideas is that tips afford a quick method that is easy to record an initial thought or concern (e.g., in real-time or near-real-time) without requiring any specified level of detail. The request engine 24 provides a mechanism to enable a user to supply more complete details at a later time, such that tip converter can convert the initial tip to a corresponding idea, if desired. The corresponding tip and related information can be stored as tip data 28 in the knowledgebase 29.

As an example, in response to a user identifying a safety concern at a specified location in a given facility, the request engine 24 can solicit additional information about such concern from the user that submitted the tip. In response to the user specifying additional information about the tip, the tip can be converted by the tip converter 26 into a corresponding idea. An idea thus corresponds to the next phase in the process innovation.

The system 10 also includes an idea manager 30 that can be programmed to manage ideas. The idea manager 30 includes a user interface 32 that can be utilized by users to create and edit ideas as well as to vote or comment on ideas created by other users. The functionality of the idea manager 30 for a given user may vary based on the role of an individual within the organization. For example, all users can comment and vote on ideas via the user interface 32. An authorized user (e.g., having a leadership or managerial role in an organization) can also employ the user interface 32 to approve or adopt an idea for implementing a corresponding experiment. As noted above, the tip manager 16 can also be utilized generate an idea, such as by converting a tip to an idea in response to supplying sufficient information via the corresponding tip user interface 22. The idea manager 30 can also include an idea generator 34 that can be programmed to generate an idea in response to sufficient information being input by a user, such as via one or more input devices (e.g., devices 18).

An idea can include a variety of data fields, such as including a name for the idea, a priority, a score, a status under description of what the idea entails and an identification of the user who contributed the idea. Such data can be stored as idea data 36 in the knowledgebase. The idea data 36 thus can be modified in response to users voting on a given idea, which voting can be implemented via the user interface 32 in response to user input. The idea data 36 can also be modified in response to an authorized user editing a given idea. The idea manager 30 can also include an idea ranking module 40 that can be utilized to compute a rank of ideas based on ranking criteria. For example the idea ranking module 40 can employ a metric to compute a score for each of the ideas that have been generated. The metric can involve objective and/or subjective criteria.

As a further example, the ideas that have been generated can be evaluated and voted upon by a selected subset of authorized users, such as can correspond to an idea evaluation committee. Each of the users in the evaluation committee can employ user input device to access functionality in the user interface 32 to vote accordingly. The idea ranking module 40 can, in turn, rank the ideas based on the committee votes for further consideration, approval and voting.

The idea manager 30 can also include a validator 42 that can be utilized to validate or approve an idea for generating a corresponding experiment to ascertain the efficacy of the idea for the business or organization. Thus, an authorized user or group of users (e.g., having a sufficiently high leadership role within the organization) can employ the user interface 32 to select an idea and employ the validator 42 to approve the idea for experimentation.

As a further example, the idea manager 30 can also be programmed to automatically send messages or requests to users (e.g., staff) to solicit ideas for experiments (e.g., similar to the functionality of the request engine 24). For instance, such automatic requests can be sent in response to analyzing data for identifying trends to determine various concerns for the organization. Requests can also be sent intermittently or periodically to help engage users. Thus, in response to receiving a request, a user can submit an idea to the system 10 via a variety of different devices 18, which may be the same or different from the mechanism used to send the request. For example, the user can employ the device 18 to submit an idea via a corresponding mechanism, such as email, voicemail, an online form and the like.

The system 10 also includes an experiment manager 44 that can be programmed to manage various aspects of an experiment. The experiment manager 44 can communicate with the idea manager to exchange information, such as including a request to approve an idea for experimentation. Information and data relating to an experiment, including experiment parameters, data results from implementing the experiment and the like, can be stored as experiment data 46 in the knowledgebase 29.

In response to an idea being approved for experiment, the experiment manager employs a designer 48 to create and design an experiment. An experiment can include a variety of parameters that can be stored as part of the experiment data 46. For example, an experiment can include a title, a hypothesis, a financial information associated with implementing the experiment (e.g., anticipated or actual cost), as well as timing information (e.g., start time, stop time). An experiment can also be implemented in multiple phases that can be specified, such as including an experiment phase and a control phase for implementing the experiment. Results and analysis associated with a given experiment that is being performed or has been performed can also be stored in the knowledgebase 29 with the experiment data 46.

An experiment can also include one or more key performance indicators (KPI's) that can be monitored during the experiment. The designer 48 thus can include a set of programmable tools to create new experiments, including by selecting and/or creating one or more KPI's that are to be monitored. The designer 48 can also establish input devices or other resources that provide measurable values for analysis during a given experiment. The designer 48 can also set one or more thresholds that can be compared relative to the measurable information values for providing an indication of the progress of the experiment. The system 10 can monitor probe data (also referred to herein as behavior probe data) from various input sources, including probe devices 18 and other sources of information. For instance, the probe data can include information specifying location or proximity, movement of people or objects, identity of persons or things, and associated timing information for data being obtained. Probe data can also include observations, such as can be made by patients, physicians, clinical staff and non-clinical staff. The probe data and/or data derived from the probe data can be stored as part of the experiment data 46. KPI threshold parameters, data parameters, real-time displays and historical trending charts can also be set up in conjunction with and utilized as part of each experiment, and such parameters can also be stored as experiment data 46.

The experiment manager 44 can also include an execution engine 50. The execution engine can be utilized to accept data that is being monitored for a KPI as part of the experiment. For existing KPIs, data can be acquired before, during, as well as after the experiment, which data acquisition can be leveraged for an experiment that is designed to utilize data already being acquired. During an experiment, the execution engine 50 can monitor data in real-time such as to display graphs or other indications associated with the KPIs that have been set up via the designer 48.

An instance of the execution engine 50 for a given experiment further can employ one or more data capture modules 52 to capture data from one or more behavior probe devices (e.g., corresponding probe devices 18) for the given experiment. The data capture module 52 can be implemented as a method programmed as an interface to receive and/or retrieve data from one or more predetermined resources configured to provide information either corresponding to a given KPI for data from which a given KPI can be determined. As an example, the data capture module 52 can receive probe data from staff (e.g., staff probes) customers or patient (patient probes). The probe data can be captured in a variety of forms and from a variety of different devices depending upon the experiment and types of data that are to be collected.

By way of further example, the data capture module 52 can be programmed to collect information from one or more probe devices 18 pertaining to one or more user behavior. The data capture module 52 can collect such information from different types of devices, such as may include smart phones, RFID readers, or the like. The data capture module 52 can collect such data from devices carried by a customer or employee and store data representing the individual's behavior.

As one example, behavioral data (e.g., including location, time and identity) can be collected from a probe device 18. Such probe device 18 can be implemented as a radio frequency identification (RFID) based location device, a global positioning system (GPS) device, smart phone or other type of device that can be utilized to provide behavioral data for a person or activity. As a further example, behavioral data (e.g., temporal information, location and/or user identity) can be collected for monitoring an ingress and/or egress of persons relative to a room or other location. Such data can be provided to the system 10 directly by the system 10 via a receiver (not shown), such as an RFID reader (or other detection device) that can be distributed at various locations to monitor RFID tag information that can be attached to persons that are being monitored as part of the experiment. Alternatively, other types of devices, such as implementing a short-range communication technology (e.g., near field communication (NFC) or Bluetooth), can be utilized to communicate probe data to the system. The behavioral probe data can be stored as part of the experiment data 46 for a given experiment, for example.

As a further example, an RFID tag can be implemented as battery-assisted RFID device that is mounted to a badge or other wearable or portable structure. An RFID reader thus can interrogate the RFID device to detect movement or proximity of a given RFID device and in turn record location, time information as part of the experiment data 46. Additionally, the RFID device, being battery powered, can transmit a signal in response to a user pressing a micro button to in turn transmit data. The received data can be collected by the data capture module 52 and associated with the particular identifier to report on an observation, such as quality, safety, cost or efficiency.

Additionally, in the context of patients, micro buttons can be utilized to report on one or more aspects of the patient experience. As an example, a communication device (e.g., an RFID device, a smart phone, or the like) can be programmed to report specific experience information, such as pain, discomfort, indicate an experience as being positive or negative, or the like. The communication of such information from the device can be provided by the person in real time with the condition or experience for which the feedback is being provided. The communication from the device can be unidirectional or the device can implement bidirectional communication. For example, bidirectional communication can provide a closed loop communication session (e.g., via a wireless technology) in which a response is provided from the person in response to a request or other stimulus (e.g., audible, visual or both) that is received at the device. The feedback from the device can include binary or other discrete measure of patient's experience. Alternatively, in other examples, a continuous scale can be utilized to measure and report on the patient's experience via the device.

The execution engine 50 can also receive data from other sources and in other forms depending on a given experiment. For instance, staff and patients can enter observations and information relating to the experiment via a corresponding user interface 54, such as using a corresponding device 18. The execution engine 50 can acquire all data received for each respective experiment and store such data as part of the experiment data 46. As mentioned, data can be acquired in real-time and be utilized to display progress associated with the experiment, such as via the user interface 54.

The experiment manager 44 can also include an analyzer 56. The analyzer 56 can be programmed to perform predetermined calculations on the experiment data 46 that can provide an indication of the progress of a given experiment. The analyzer 56 can perform the computations in real time in response to the data capture module 52 collecting probe data, for example. Alternatively, or additionally, the analyzer 56 can perform such computations based on data that has been acquired over a time period, such as a selected portion of the experiment phase. The analyzer 56 can also compute statistical information comparing experience results to pre-experience bench marks or other standards or experiments that may have performed within a given enterprise. The analyzer can store the results of such calculations in the knowledgebase 29 as part of the experiment data 46. As mentioned above, the calculations can also include metadata, such as to provide information about the type of data or temporal information (e.g., a time stamp) to facilitate evaluation of the experiment. The analyzer 56, for example, can provide analysis data for a given experiment based on which trending charts and graphs of the collected data during the experiment period that can be presented to one or more users via the user interface 54. All such analysis and statistical information can also be stored as part of the experiment data 46 in the knowledgebase 29.

The system 10 can also include a dashboard module 58 that can be utilized to display information associated with a given experiment to provide immediate feedback about the progress of an experiment to one or more goals. The dashboard module 58 can present the information in a variety of forms, such as part of a GUI that includes color coding, a numerical scale, a dial or the like. The information provided by the dashboard 58 may vary depending upon the role (or authorization) of the individual user employing the dashboard. Alternatively, the dashboard may present the same types of information to all users regardless of their role.

The system 10 can also include a reports module 60 that can be utilized to generate one or more reports associated with use of the system 10. The reports module 60 can provide the reports in different forms, such as output to a display via a GUI or printed, and can send reports via various forms of communication. For instance, reports can be utilized to provide an indication of staff engagement, user contribution such as in the form of tips and ideas. The reports module 60 can also generate reports to provide an indication of the impact of the experiments on the overall operational and behavior and culture of the team or group implementing the experiment. For instance, a report can be generated to demonstrate the effect of a successful experiment and its integration into an organization culture.

The system 10 can also include a KPI manager 62 that is programmed to manage KPI's, which may be stored in the knowledgebase 29 as KPI data 64. As mentioned above, the KPI can be implemented as a metric or function that is utilized to measure the results of change in behavior or performance of one or more parameter. The KPI can be real-time or nearly real-time measurements or can be time-based measure.

As one example, a KPI for a doctor's office may be patient wait time. Thus a KPI can be established to determine an amount of time a patient spends in a waiting room from check-in until the time the patient walks out of the waiting room. For example, the wait time may be measured as the difference between the time when the patient checked in with the receptionist and the subsequent time detected when the patient exits the waiting room (e.g., using an RFID reader configured to detect a RFID device carried by the patient). Alternatively, this time may be monitored by the receptionist and entered manually (e.g., via the user interface 54) such as during implementation of an approved experiment.

As another example, a KPI can measure doctor-patient face time. In order to track such a KPI, each patient and each doctor will include a device that can be detected within a room. For example, a doctor and patient can include respective cards or other devices with RFIDs or employ NFC configure to identify when each enters a given office room. When the system detects both within the given office room concurrently, it can compute an indication of the doctor-patient face time as the overlapping time period. As mentioned, this can be tracked for doctors or other caregivers, anonymously, or details can be tracked for each caregiver separately.

Yet another example KPI can be configured to track room usage for a facility (e.g., a hospital or clinic). By room usage, the corresponding probe data can store an indication when a given room is occupied, not occupied or both conditions can be represented in the probe data. The KPI can further be programmed to measure room usage by one or more classes of persons (e.g., patients, care givers, maintenance staff or the like), such as by provide each class of person different types of devices sufficient to distinguish between the different classes. All such information relevant to entering a room, occupying the room, and leaving the room thus can be tracked and stored as probe data for subsequent analysis in a given experiment, such as disclosed herein.

As a further example, the KPI data 64 can include a library (e.g., a set) of plural KPIs that have been designed for a given group or organization. For instance, when the system 10 is installed or prior to installation, a consultant can work with management to ascertain the goals of the group or organization. Depending on the goals, a set of KPIs can be provided. Means for acquiring information that provides a measure of a related performance condition can also be defined established for each KPI. For instance, an authorized user (e.g., administrator, leader or the like) can associate one or more sources of relevant data for a given KPI and program the KPI manager to capture corresponding data that is relevant to the given KPI. The data can be stored in the knowledgebase 29, for example, in the experiment data 46 that can be programmatically linked to a given KPI. In this way, the system 10 can be configured to obtain corresponding information from one or more data sources for each KPI such that, when a KPI is activated for use in a given experiment, appropriate information can be aggregated for analysis thereof the KPI.

As mentioned above, the data sources assigned to a KPI can include various types of probe devices 18 as well as other sources of information meaningful to the KPI. The other sources of information can be obtained from customers, personnel, which can entered directly or indirectly via a probe device 18 or be stored in one or more other data sources (e.g., electronic medical records, scheduling systems, or the like). As one example, the probe devices 18 can be implemented as including sensors that can be configured to acquire information, corresponding to probe data, about a state or condition of one or more of a person, place or a thing or relationships therebetween. For instance, a sensor device, corresponding to the probe device 18, can be utilized to obtain information about location of people, such as customers (e.g., patients) and personnel, and relevant timing information. Such acquired information can include identity data that explicitly identifies each individual source of information, such as by a unique identifier or name. Alternatively, the identify data may be anonymous such as by identifying each individual as being assigned to a predetermined role or group (e.g., patient, doctor, nurse, and the like) within the organizational context, such as to facilitate HIPAA compliance. An even greater level of anonymity can be afforded by having no ascertainable identity associated or tracked each device, as provided in corresponding probe data. For instance, a set of detectable devices (e.g., communication-enabled cards) can be utilized by each of the participants without distinction as to which device each participant uses. When identity is so obfuscated, the meaning of the information collected in the associated probe data will either need to be inferred from the probe data or it may remain ambiguous.

Timing information can also be stored as timing data in memory, such as part of the knowledgebase 29. The timing data can provide timing information about a duration for each state or condition being monitored (e.g., by a sensor). The timing data can be an absolute chronological time, such as from a clock, or it can be an elapsed time corresponding to a duration of the state or condition. The timing data, for example, can indicate when a respective state or condition begins (e.g., detecting when an identified person enters a room). The timing data can also indicate other timing information, such as how long the individual is in the room, when one or more other identified persons enter the same room, when each person leaves the room and the like. The meaning and significance of timing information for a given state or condition will depend on the context and circumstances for the state or condition defined in a given KPI, such as may be explicit or implicit from the associated probe data.

The probe devices 18 can also be implemented as other data input devices configured to receive feedback from customers (e.g., patients) and/or personnel in real time or near real time. Customer survey data, such as can be entered online, obtained via a paper forms or the like, can also be stored in memory as survey data that can be analyzed to provide a measure of performance for one or more KPIs. The source of such survey data can be identified (e.g., by identity data), which can be a unique identifier or an anonymous identifier

The KPI manager 62 can include a KPI user interface 66 that can be utilized to create or edit a KPI. That is, each given KPI can be configured to monitor and track information from one or more data sources, such as disclosed herein. Additionally, as part of a KPI, threshold values and goals associated with the KPI can also be programmed via the user interface 66 such that the parameter or parameters being measured by a given KPI can be analyzed relative to the threshold or goal. The user interface 66 can also include one or more indicator to provide an indication of the value which may be the current real-time value as well as historical information for the respective KPI.

A given experiment can utilize one or more existing KPI's that can be selected from KPI data 64 in the knowledgebase 29 and implemented within a given experiment for providing a measure of a performance condition relevant to the goals of the experiment. That is, a user can establish an experiment from a set of existing KPIs that have been stored in the knowledgebase of the KPI data 64. Alternatively, a user can create and configure a new KPI via the KPI manager 62 that can be utilized as part of an experiment. The new KPI can be stored as part of the KPI data 64 and can be utilized by any other user in the system 10. By storing KPI's in the knowledgebase 29, creation of experiments and criteria to evaluate as key performance indicators can be facilitated across an organization.

As a further example, the KPI data 64 can comprise a library of KPIs having various measurement methods that can be utilized for measuring various performance criteria for experiments that can be implemented via the system 10. In addition to receiving data directly as part of an experiment, KPIs can also utilize information that can be received via other applications and across other data processing centers. For instance, the system 10 can employ an application interface (API) to access information and resources from other systems and sources for measurements that may have already been made or are being made by other existing systems. As an example, the system 10 can employ an API to access an electronic health record (EHR) and particular data that may have been obtained for a given patient or group of patients. Additionally, the system 10 can employ a web-based API to access web services, such as to request data from an identified source of data (e.g., a web-based application). Additionally, other systems may utilize APIs to access data from the system 10, such as other external dashboard applications or the like.

The KPI data 64 can be implemented as an interrelated tree-like structure that demonstrates interrelationships between the set of KPIs, such as one KPI may affect (or influence) the measurements of one or more other KPIs. In this way, experiments that are conducted can also be utilize to identify and measure the impact that improving KPI in one area may affect the KPIs in other areas, such that the system 10 can ascertain an impact on the experiment on the overall behavior and operational process. That is, the system 10 facilitates creating a balance between the various KPIs and how they interrelate and affect each other such that continuous improvements can be made.

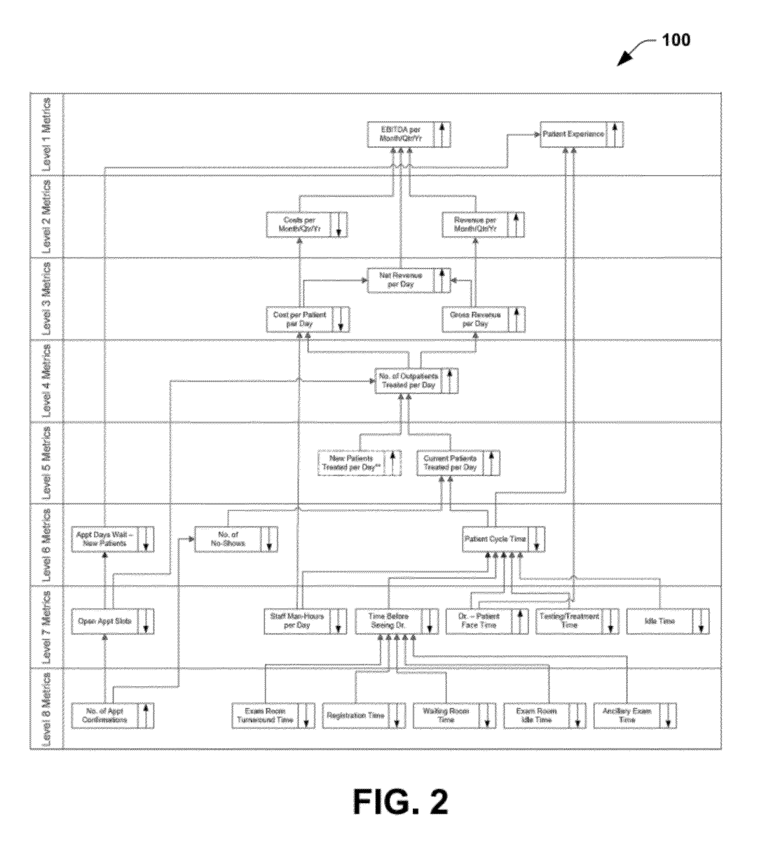

As one example, FIG. 2 depicts a KPI tree 100 demonstrating eight levels of interrelated metrics for corresponding KPIs. In FIG. 2, directional arrows connected between nodes at each levels indicate the direction (or directions) of influence that a given KPI has on one or more other KPI's in the tree 100. Additional arrows within each KPI node demonstrate a desired direction for the value of the KPI metric. For instance, nodes labeled “Appt Days Wait Time—New Patients,” “No. of No Shows,” and “Patient Cycle Time” each has a downward arrow indicating a desire to decrease the measured values. In contrast, nodes labeled “New Patients Treated Per Day” and “Current Patients Treated Per Day” each has an upward arrow indicating a goal to increase these values. Thus, a KPI tree can be generated for a business entity or other organizational structure and results for each respective KPI in the tree can be applied to the nodes to provide information about the impact each active experiment has on each of the metrics being tracked. The example tree 100 in FIG. 2 demonstrates KPIs in the context of healthcare organization. The tree 100 thus can be used (e.g., by a leader or administrator) to determine the potential impact that an experiment might have on other KPIs.

Returning to FIG. 1, the system 10 can also include a continuous positive reinforcement (CPR) engine 70. The CPR engine 70 can interact with the tip manager 16, the idea manager 30 and the experiment manager 44. The CPR engine 70 can be utilized to disseminate and distribute CPR to users based on quantified levels of engagement (e.g., corresponding to interaction or lack of interaction) with the system 10. The CPR engine 70 includes a CPR generator 72 that can be programmed to generate CPR such as can be provided via one or more forms of communication. The forms of communication can vary for each user, such as depending on the types of communication devices that a given user may possess. For example, CPR can be sent directly and personally to users. CPR can also be sent globally as to be perceptible to all users, such as corresponding to a leader board that identifies the level of engagement for all users or a subset thereof. For example, the CPR engine can quantify the level of engagement as based on interactions during a moving time-averaged window such that more recent engagement can be afforded a greater weight relative to older instances of engagement.

The CPR engine 70 also includes an analyzer 74 to ascertain whether the CPR generator 72 should generate CPR and, if so, the type of CPR. The analyzer 74 can cooperate with the various modules of the system 10, including the tip manager 16, idea manager 30 and experiment manager 44 to track and recognize contributions and the level of engagement of users. The analyzer 74 can track, for example, tips that have been input by users, ideas and the quality of ideas submitted by users as well as the experiments and the success of experiments. The analyzer 74 can ascertain the relative success of a user's engagement and cause the CPR generator to generate an appropriate type and form of CPR accordingly. Additionally, the analyzer 74 can be programmed to monitor votes and comments made users for each idea that is submitted. The voting and ranking of ideas that have been submitted further helps promote the culture of continuous innovation for the corresponding business processes, such as to improve quality and lower costs. As a result, the CPR engine 70 can create a culture that empowers and keeps users engaged in using the system 10 by providing CPR.

As an example, the CPR generator 72 can automatically generate virtual medals that can be presented on a graphical user interface displayed prominently on a website or other manner (e.g., digital signage). Information can also be printed and posted in a prominent location to recognize an individual user's contributions via the system 10. For instance, in addition to generating virtual medals, demonstrating and recognizing engagement and contribution of users in the system, such recognition further provides feedback that encourages users to continue and maintain their involvement of the system. Medals and other forms of recognition further can be utilized within an organization as a basis for other forms of incentives. For example, metals can be converted to other types of incentives such as can include stickers that can be placed on badges, monetary compensation, prizes or other awards.

As mentioned, the CPR generated by the CPR generator 72 can be documented and stored as CPR data 76 such as in the knowledgebase 29. The CPR data 76 for a given individual can further be utilized as part of a performance review. For example, a user can employ the CPR engine 70 (or an associated GUI) to retrieve their corresponding CPR data documenting their contributions over a period of time to enhance the review process within the business organization. Moreover, by utilizing CPR in this manner, the system 10 fosters an environment or culture that encourages continuous improvement and innovation in the operational business process for an organization.

The system 10 can also include a search engine 78 that is programmed to search the knowledgebase 29 based on a query. For example, the query can include one or more search terms related to tips, ideas and experiments or comments that may have been stored in the knowledgebase. The search engine 78 can provide the content directly or it can be provided via hypertext links or otherwise. The search engine 78 can correspond to a commercially available or proprietary search engine that can be utilized to query the knowledgebase 29 or other resources for operational and behavioral data stored therein. The search engine 78 can constrain the search for a given group to team within an enterprise or organization, or the search can be conducted globally across the knowledgebase 29 that encompasses the enterprise or organization. In this way a user may be able to locate data pertaining to a previously submitted idea or experiment to facilitate process innovations.

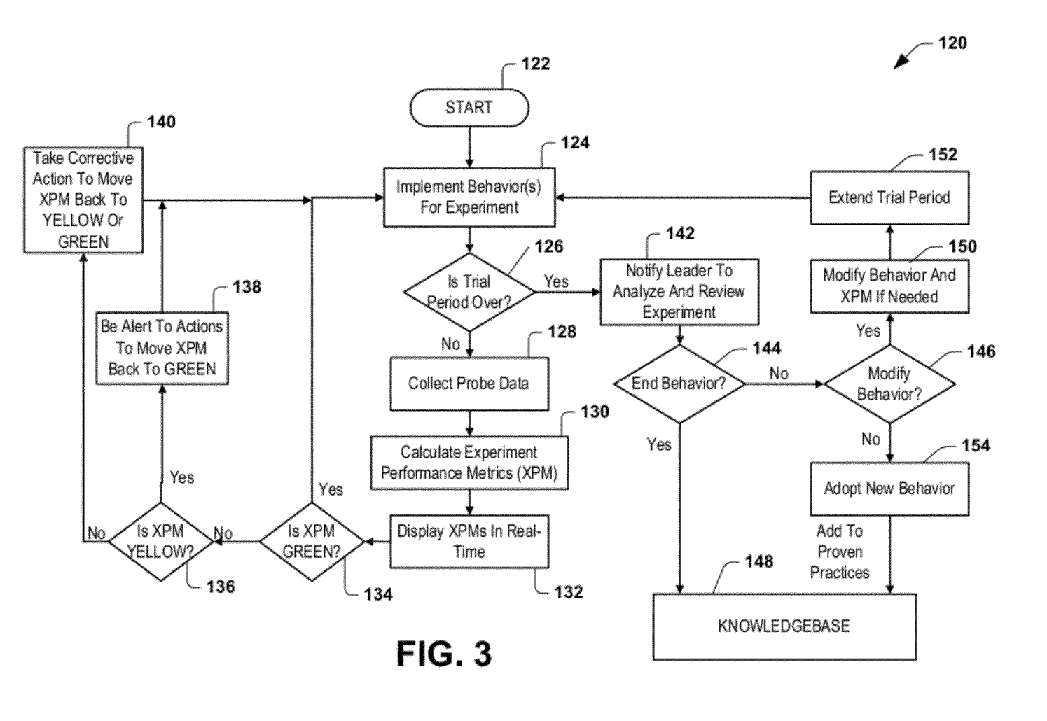

FIG. 3 depicts an example workflow diagram demonstrating for implementing an experiment within the system (e.g., the system 10 of FIG. 1). The method 120 begins at 122 such as in conjunction with establishing an experiment and the type(s) of behavior to be monitored. This can include selecting one or more KPIs from the library of KPIs that are configured to monitor relevant parameters and behaviors for the organization implementing the experiment. As disclosed herein, a given KPI can be configured to capture probe data from one or more sources.

At 124, the behaviors can be implemented for the experiment. This can include personnel engaging in behavior that modifies existing procedures or protocols for a business process and/or engaging in new behavior as defined by the experiment. Such new behaviors, for example, can be engaged in by a customer (e.g., patient) such as in response to directions from personnel for carrying out of one or more functions associated with operations. The goal of the experiment can be established to determine whether implementing the new behavior or behavior modification that is required by the experiment will improve some facet of business operations or customer satisfaction.

Once the behavior(s) for the experiment are being implemented, the method proceeds to 126 and a determination can be made whether the trial period has ended. If the trial period is not over, the method proceeds to 128 and probe data is collected. At 130, experiment performance metrics (XPM) can be calculated based on the probe data. The calculated XPM can then be displayed at 132 (e.g., in a dashboard GUI), such as in real time based upon the calculated XPM. Thus, as the probe data collected changes, the calculated XPM and corresponding display can also change accordingly to reflect updated probe data.

As part of the experiment, one or more ranges for evaluating the experiment can be set to quantify whether the resulting metrics that are being measured are within the expected operating parameters. As one example, a simple three range classification of the XPM can be implemented to provide status information for the experiment, such as good, caution and alert. The status information can be presented in a dashboard GUI, for example, with color coding to identify the current (e.g., real time) status for the experiment based on the calculated XPM. For instance, green can corresponding to good, yellow can indicate caution and red can indicate an alert mode requiring corrective action.

At 134, a decision can be made whether the XPM indicates good experimental results (e.g., is it green status). If the calculated XPM has a value that is within the “good” range, the method can return to 124 and continue implementing the corresponding behavior for the remaining duration of the experiment. If, at 134, the decision is negative, indicating that the calculated results are not in the good range, the method can proceed to 136. At 136, a decision can be made if the calculated XPM has a value that resides in the “caution” range. If the XPM results indicate caution, an alert can be provided to influence behavior to take actions to facilitate moving the XPM back to the “good” range. At 138, the alert can be provided, such as by sending a message to the patient care team that is implementing the experiment. The message can include instructions to facilitate moving the resulting XPM back to within the “good” range. If it is determined that the calculated XPM is not in the caution range or higher, from 136 the method can proceed to 140. At 140, corrective action can be taken to move the XPM back to yellow or green. For example, at 140 an alert can be triggered, which can provide an alert message to the leader and/or other members of the XPM team. The alert can identify the resulting experiment has having a metric that is below some predetermined threshold level that indicates an unsatisfactory results. From 140, the method returns to 124.

If at 126 it is determined that the trial period has ended, the method can proceed to 142. At 142, one or more leaders or other members authorized group can be notified to analyze and review the results of the experiment. The results can be displayed as a graphical map, timeline or the like, such as via a GUI. The leader or leadership team can evaluate the results to determine whether the experiment was successful. From 142 the method proceeds to 144 to determine whether to end the behavior, such as based on the results. If it is determined to end the behavior, indicating that the experiment did not result in reaching the goals that was set initially, the corresponding results and KPI information and the XPM data can be archived by storing the results and experiment data in the knowledgebase at 148 (e.g., the knowledgebase 29 of FIG. 1). If a determination is made at 144 not to end the behavior, the method can proceed to 146. This can be based a decision to continue the experiment with or without changes.

At 146, a determination is made as to whether the behavior or other aspects of the experiment should be modified as part of the continuing experiment. If it is determined to modify the behavior, the method proceeds from 146 to 150 in which the behavior component for the experiment can be modified. The XPM can also be modified. With the modified behavior and the modified XPM (if needed), the trial period can be extended at 152, such as by setting a new end date. From 152, the method returns to 124 and the modified behavior can be implemented for the experiment at 124 and the process can continue. If it is determined at 146 not to modify the behavior, such as if the goal of the experiment was reached, the method can proceed to 154. At 154, the new behavior can be adopted. The adoption of the behavior can correspond to a situation where the behavior implemented in the experiment resulted in a successful outcome in which one or more respective goals have been met. The new behavior that is adopted at 154 can also be added to a list of proven practices. For example, a proven practice can correspond to behavioral process within the organization considered to result in improved operations, such as increased revenue and/or customer satisfaction. The proven practice can include a description of steps required to implement the behavior in sufficient detail to enable others to reproduce the results. A description of the proven practice and corresponding behavior can be can be added to the knowledgebase 148.

Thus, as demonstrated in the example of FIG. 3, in addition to collecting data via behavioral probes for use in an experiment, and calculating performance metrics, various tools can be employed to provide users real time information about the progress of the experiment. The process 120 further allows authorized uses to modify the behavior or XPM utilized to evaluate the progress over time to facilitate integration into actual business operations.

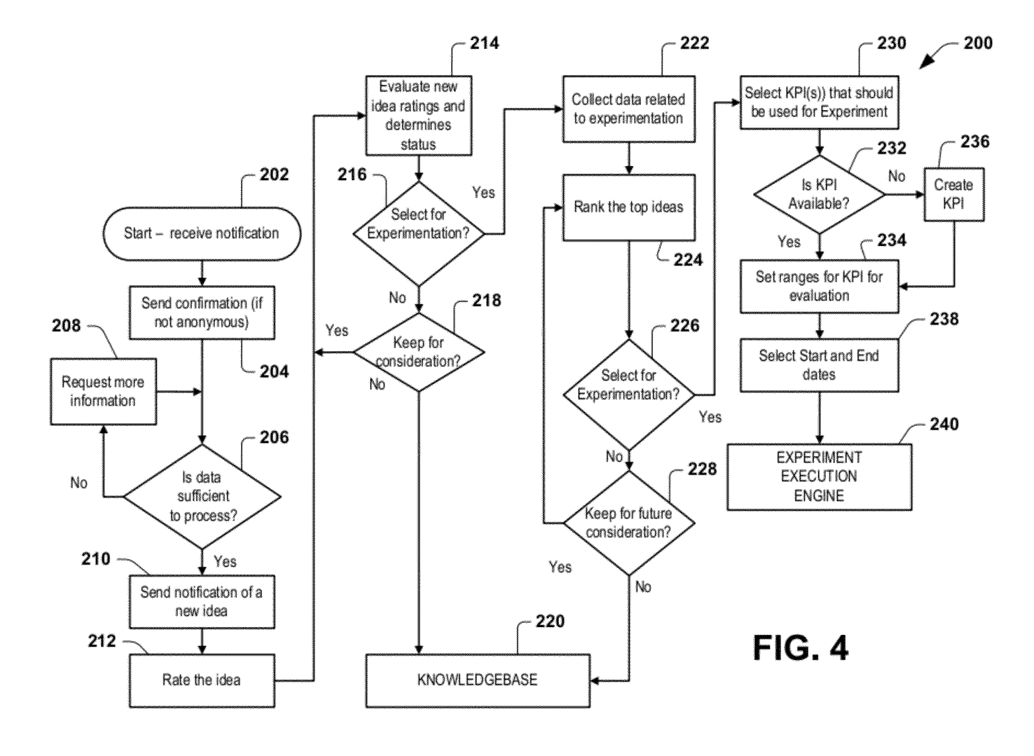

FIG. 4 depicts an example of a method 200 that can be utilized for processing an idea through a plurality of different phases into becoming a corresponding experiment. The method 200 begins at 202 such as in response to receiving a notification of an idea. Such notification can be received via email, voicemail, data entry or from another input device that may communicate with an idea manager (e.g., the idea manager 30 of FIG. 1). The notification can be anonymous (e.g., from an unidentified user) or it can be from an identifiable source. At 204, if the notification was not anonymous, a confirmation can be sent to the sender via similar means or other predetermined notification means (e.g., text message, email or the like). The identity can be provided in the notification that is received or the identification can be looked up based on the source of the notification and information that is stored for each user operating in the system. In other situations, where the originator of the idea is anonymous, no notification may be sent since the identity may not be known. As disclosed herein, an idea can be submitted to identify a concern or observation as well as to suggest a new behavior, a behavior modification, a process improvement, a change in a condition or state of a facility or a portion thereof or other process innovation.

At 206, a determination is made as to whether received data is sufficient to process as an idea within the system. The determination at 206 can be completely automated, manual or involve manual and automated operations. If the information is not sufficient to process the data as an idea, a request for more information may be sent at 208. The request can be sent via the same or different communication means from what was utilized to send the notification at 202. If the data is sufficient to process, the method can proceed from 206 to 210 in which a notification of the new idea is sent. The notification can be a publication (e.g., broadcast) to a global user interface (e.g., by the idea generated at 34 of FIG. 1). Additionally or alternatively, the idea notification can be sent to each user individually via one or more communication means, such as email, text messaging or the like. The modes of communication for sending the notification to each user can be set up in the system and stored as user preference data, for example. This notification alerts the users of a new idea and promotes user engagement. For instance, once the idea has been published to the users, users can rate the idea at 212. The rating at 212 can be based upon a predefined rating system that can be any number of ratings such as may be a discrete scale. For example, the rating scale can include a binary scale, such as indicating a user's like or dislike, or more levels can be implemented, such as a scale from 1 to 10). The ideas can be ranked according to a score, such as quantifying the ranking based on a popularity of the idea within a recent time window.

At 214, the idea ratings can be evaluated and a status of each idea can be determined. For example, the ratings can be evaluated by a leader based upon a relative quantification of a set of ideas that may exist within the system. At 215, a determination can be made as to whether the idea is selected for experimentation. If the determination is negative, the method proceeds to 218 to determine whether to keep the idea for future consideration. If the idea is not kept for future consideration, the idea can be archived into a knowledgebase at 220 and removed from the rankings. If the idea is kept for consideration, the method can return to 214 in which the various ideas existing within the system can be ranked based on user voting and the ideas can be periodically re-evaluated to determine their status.

If at 216, a given idea is selected for further consideration as an experiment, the method can proceed to 222. At 222 data related to the possible experiment can be collected. Such data may include, for example information relating to what is involved with setting up the experiment, maintenance costs and other factors that may be considered relevant for implementing the experiment into business processes. At 224, a set of top ideas can be ranked, such as based on their ranking and the data selected at 222. At 226, a determination is made as to whether a given idea is selected for experimentation. For example, the selection can be made by a committee that includes a leader or a leadership team. If the idea is not selected for experiment, the method proceeds to 228. At 228 a determination is made as to whether a corresponding top idea should be kept for future consideration. If the idea is not kept for future consideration or experimentation the corresponding idea can be archived into the knowledgebase 220. If the idea is kept for future consideration, it can be real valued at amongst other top ideas at 224.

If an idea has been selected for experimentation at 226, the method proceeds to 230 for such idea to proceed with configuring the experiment. At 230, one or more KPIs can be selected for use in the experiment for providing a quantitative measure of for validation of the idea via the experiment. A set of one or more KPIs can be selected from a library of KPIs that have been configured for a given organization or group within an organization. At 232, a determination is made as to whether each selected KPI is available. If the KPI is determined to be available, the method can proceed to 234 and corresponding ranges for measuring the KPI can be set. The range can be set for evaluating a calculated experiment metric for the KPI.

For example, the ranges for KPI evaluation can relate to a plurality of different ranges of a metric or metrics that are to be evaluated as part of the selected KPI. For instance, one approach is to set ranges corresponding to a good result, a caution result or an alert result for a given KPI. These corresponding ranges can further be utilized to implement a dashboard user interface that can provide corresponding color codes in substantially real time based on probe data that is collected. If no KPIs are determined to be available at 232, the method proceeds to 236 in which a new KPI can be created and stored in the KPI library. Corresponding ranges for the created KPI can also be set at 234 for the current experiment. Also as part of the experiment setup process, corresponding start and end dates can be defined at 238 and stored in memory for the experiment. From 238, the process proceeds to 240 in which the corresponding experiment and KPI(s) can be implemented by the experiment execution engine (e.g., execution engine 50 of FIG. 1). The experiment can be executed according to a process, such as shown and described with respect to the method of FIG. 3.

Thus from FIG. 4 any numbers of experiments can be generate in response to an idea that is submitted by a user (e.g., a member of a patient care team). Once the experiment has been created, it can be provided to the execution engine (the execution engine 50 of FIG. 1) for implementing as a process innovation. Engagement of users can be fostered during execution of the experiment such as by providing notifications about the experiment's progress. Users can also provide comments and advise in connection with the behavior(s) being measured in the experiment. This can help drive the process, which can include modifying one or more part of the experiment.

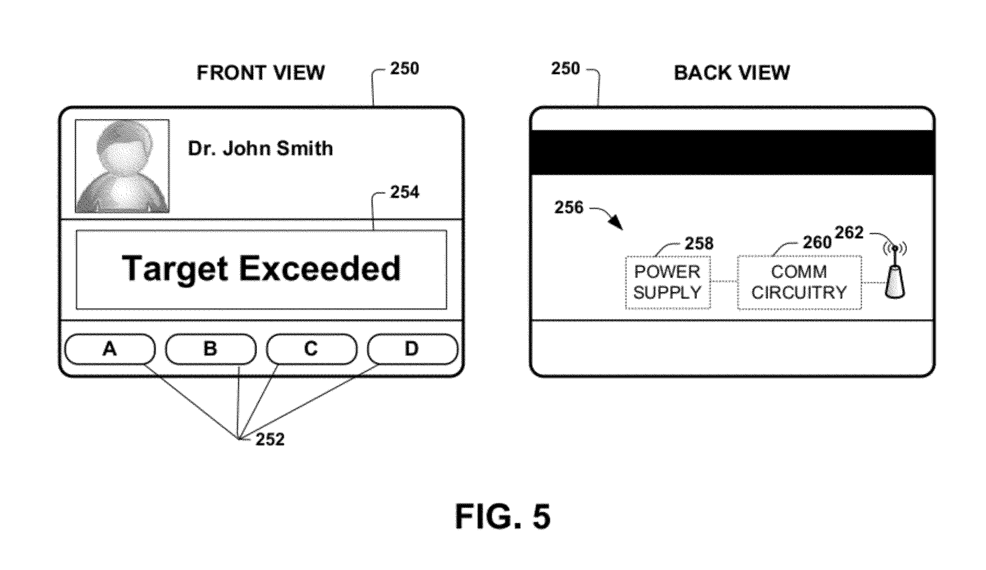

FIG. 5 depicts front and back view, respectively of an example input device 250. The device 250 can be utilized as a behavioral data probe input device (e.g., device 18 of FIG. 1). In the example of FIG. 5, the device 250 is demonstrated as a badge that includes a plurality of buttons 252 labeled as A, B, C and D, as well as a display screen 254 that can provide a code or other information (e.g., text and/or graphics) associated with an ongoing experiment.

As a further example, the device 250 can include circuitry 256 for communicating information to and/or from the device. The circuitry 256 can be configured to provide for unidirectional communication or bidirectional communication. The circuitry 256 can be encapsulated within the device or it can be affixed to a surface thereof. In some examples, the circuitry 256 can include a power supply 258, a communications device 260, and an antenna 262 configured for communicating a wireless signal, such as can be received via an antenna of a receiver within the system. Examples of wireless communications technologies that the circuitry 256 can employ include Bluetooth, NFC, RFID, WiFi and the like.

Circuitry 256 implemented in the badge, for example, may also include power supply (e.g., a battery) to enable transmission and response to activating one of the selected buttons 252. For example, buttons 252 can be utilized for different purposes such as can be interpreted by the data capture module to provide further meaning and information about an observation that is being made by a user in response to activation of a selected button. Activation of each button 252 can provide real-time input from a user such as indicative of the user's experience and/or behavior, which can vary depending on which button is activated.

As one example, the circuitry 256 can include an RFID device that is configured to generate a signal in response to being interrogated by a signal from an RFID reader. The RFID circuitry can be powered from the interrogation signal. Alternatively or additionally, the RFID device can be a battery-powered RFID device that can transmit the corresponding identifier signal, such as in response to activation of one of the buttons 252. Such RFID circuitry can be modified to adjust the signal and information identifier transmitted by the RFID device in response to selecting each button 252.

Additionally, since the input provides a real-time indicator, the system 10 can likewise provide a real-time or near-real-time message or alert in response to the user's input. For instance, in response to detecting a user input via the one of the buttons 252, such as corresponding to a negative experience indicator or an indication of pain or discomfort, the system can trigger an alert message (e.g., an email or page) that is sent to one or more appropriate individuals, such as for providing immediate assistance to the user. Thus, each of the buttons 252 can be assigned a purpose such that activation thereof has a prescribed meaning in the system 10.

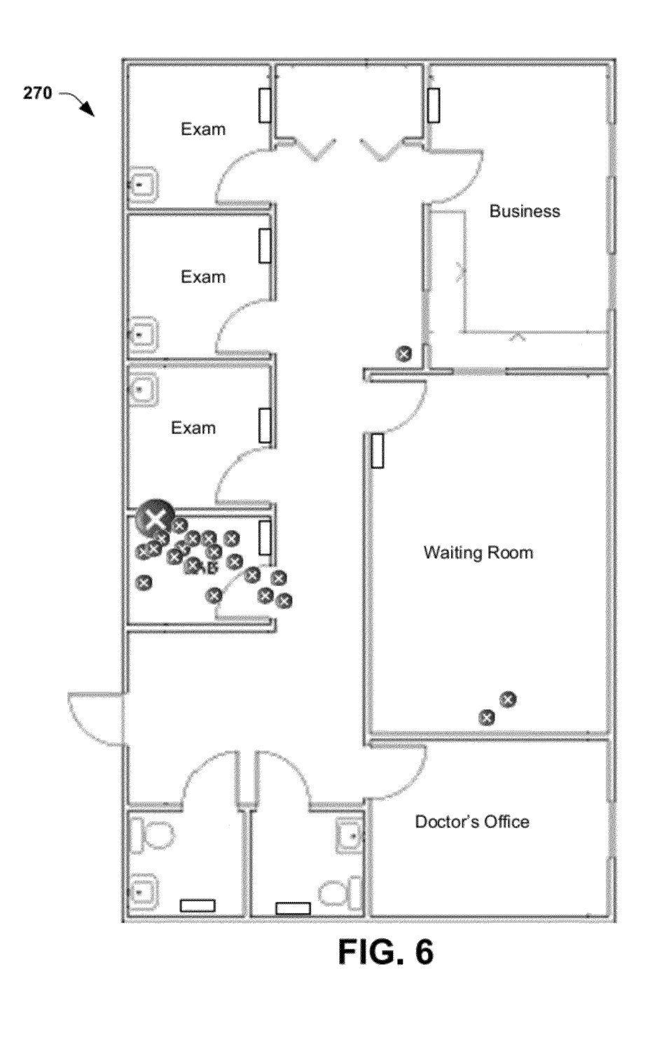

FIG. 6 demonstrates an example of a location map 270 that can be generated (e.g., as a GUI) through the use of behavior probe device, such as an RFID-based device such as demonstrated in FIG. 5. In FIG. 6, a plurality of “X's” are depicted at selected positions in the location map 270, such as corresponding to locations where users had made observations via a probe device. For instance, the observations can be entered into the system as tips or alerts via a behavioral probe device (e.g., pressing a corresponding button on a badge to transmit the corresponding signal to a receiver such as of the RFID reader). In this way, a map can be generated and reviewed by personnel, such as a selection committee or leader for generating ideas and/or experiments. Alternatively or additionally, the system 10 can be programmed to detect the occurrence of tips at a given location and automatically send a message (e.g., email, page or the like) to a leader or administrator to review the tips associated with such location. Additionally, when the tips are from identified users, further information can be requested from each user who entered the tips, such as an email request to convert a tip to a corresponding idea for evaluation.

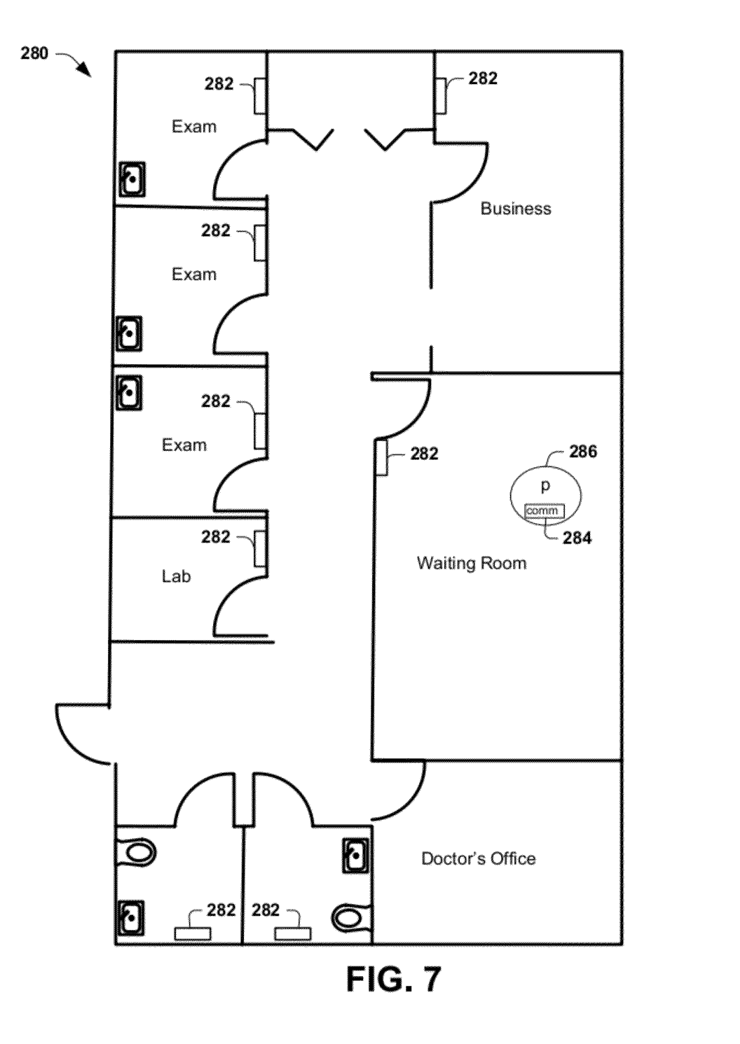

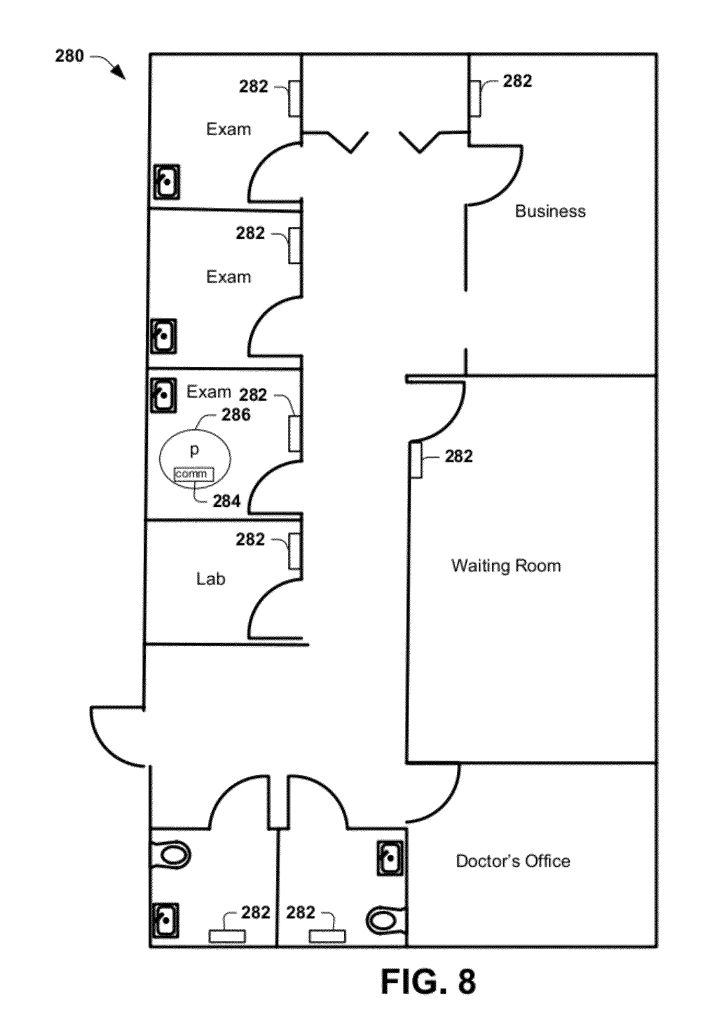

FIGS. 7 and 8 depict examples of a location map plan 280 (similar to the map in FIG. 6) in the context of being utilized as part of an experiment for determining patient wait time. In this example, a plurality of detectors (e.g., RFID readers, NFC receivers or the like) 282 can be positioned in various rooms of the facility for detecting the proximity of a portable probe device 284. In the example of FIGS. 7 and 8, a portable probe device 284 can be attached to or otherwise carried by a patient 286. The probe device 284 can be configured to transmit an electromagnetic signal that is detected by detector 282 when the probe device is located within a respective room. The signal can include information that includes a unique identifier for each user. Alternatively, the identifier can identify the user as belonging to a group or category of user (e.g., a patient, doctor, nurse, or other caregiver). As another alternative, the signal from the probe device may provide for user anonymity. Thus, the particular type of information may vary depending on the specifics of an experiment being implemented.

As an example, a check-in time can be recorded for the patient and at which time the patient can be given the probe device 284 and remain in the reception area until moved by staff. In FIG. 8, the patient 286 is demonstrated as having been moved to an exam room that contains another detector 282. The probe device 284 with the patient 286 can send a signal (if battery powered) that is received by the detector 282. Alternatively, the detector 282 can interrogate the probe device 284 and receive a corresponding response signal from the probe device, such as can be provided in response to the patient entering the room within range of the detector 282. The probe device can provide various kinds of behavior information, such as location, time, source, proximity, movement and/or flow information associated with the probe device. The response signal can also encode data that uniquely (at least unique to the system) identifies the probe device. The detector 282 can be connected to a server (directly or indirectly) or other device to communicate the captured information (e.g., a user ID) from the probe device 284. The received information can be encoded with other behavior data that can be provided from the probe device or be inferred from the environment and/or the experiment being implemented. The corresponding behavior data can be analyzed by a data analysis module, as part of the experiment, such as to compute a wait time for the patient from check-in through being placed into an exam room.

As a further example, a doctor or nurse can also have a probe device (e.g., an RFID reader, NFC communications device or the like) that can be detected upon entry into the same exam room where the patient resides. Such elapsed time between patient entering the room and nurse or doctor entering can further be recorded to ascertain a wait time to see a medical professional, such as can be implemented as part of the same or different experiment. Similar types of experiments can also be utilized to monitor and determine other criteria as part of an experiment.

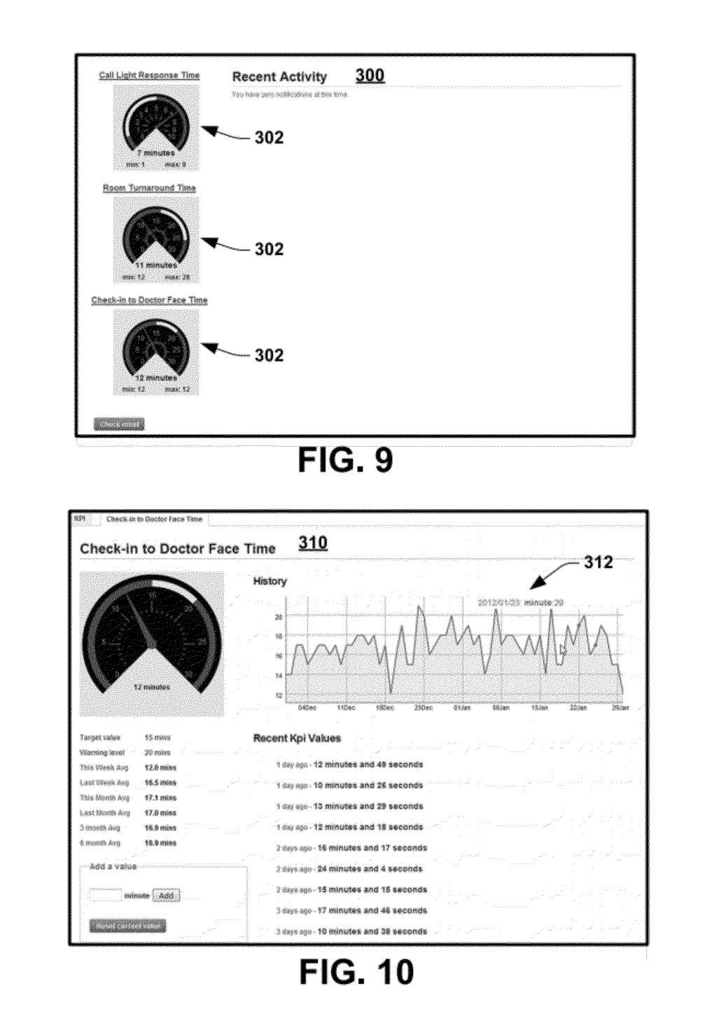

FIG. 9 demonstrates an example of a dashboard GUI 300 that can be implemented for a department of a hospital or other medical practice group. The dashboard 300 demonstrates KPIs for a plurality of different experiments being currently conducted in the form of a representation of interactive graphical gauges 302. In the example of FIG. 9, the gauges depict real-time information for experiments that include call light response time, room turnaround time and check-in to doctor face time. KPIs for other experiments could also be implemented based on the contents herein. The needle can be positioned in a gauge-like representation to demonstrate an average KPI for the experiment being conducted. Color coding can also be utilized ranging from red, yellow to green for demonstrating the relative success for each KPI. The example dash board GUI can be generated, for example by a dashboard module (e.g., dashboard 58 of FIG. 1).

Additional details about a given experiment could be obtained, for example, by activating one of the GUI elements with a user input device, such as a mouse, touchscreen or the like. For instance, FIG. 10 demonstrates details for a check-in to face time GUI element, such as can be selected by a user. In FIG. 10, the GUI 306 includes a plot of history for KPI values as a function of time, demonstrated at 312, which time can be user configurable. Additional statistics computed from probe data captured for the experiment can also be shown as well as a set of recent KPI data values.

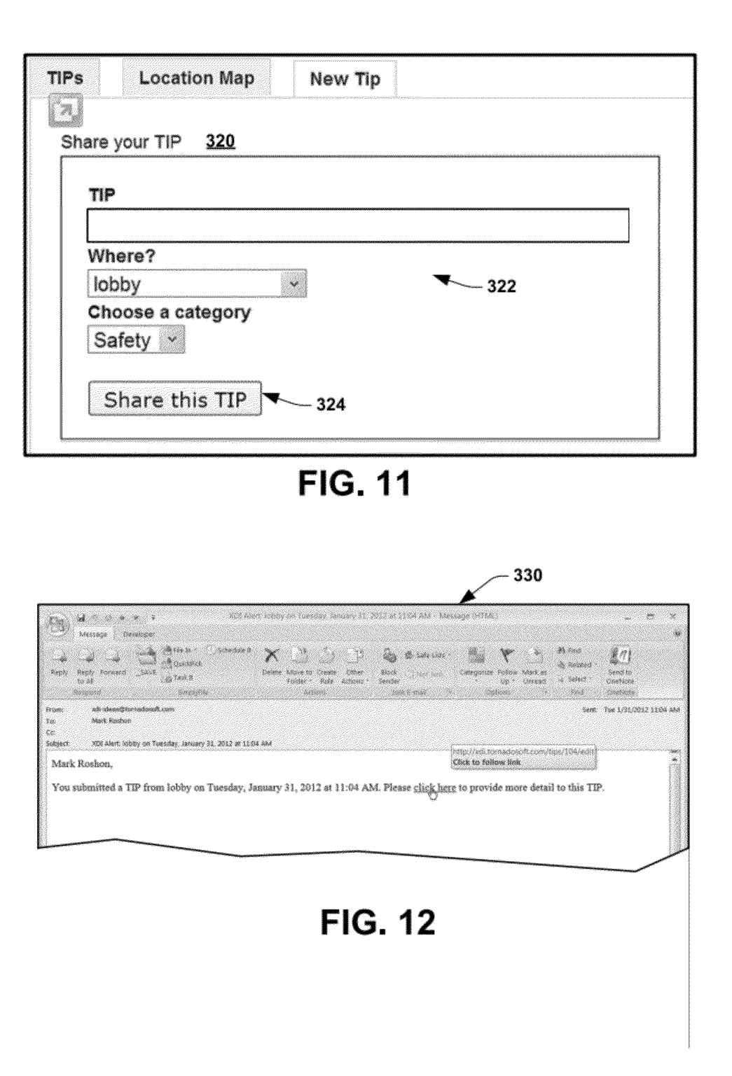

FIG. 11 depicts an example of a GUI 320 that can be employed to create and share a tip. As mentioned above, a tip can correspond to an observation or experience by a user, and can be entered via a variety of user input mechanisms such as described herein. The GUI 320 can be activated from a main screen, such as in response to selecting a create tip GUI element. The GUI 320 thus can elicit information from the user, such as what the tip is, a location and a category. The GUI can be programmed to receive information in various forms of user input GUI elements, which can include free form text entry dialog box and/or drop down menus of preprogrammed fields. The tip user interface element, for example, can provide a set of user input fields, such as including a text box for entering a description of the tip (if applicable), a location such as can be provided as (e.g., via a drop-down list of locations) for a given facility and a category for the tip (e.g., safety, quality or cost related categories). In response to entering information for the tip, a user can click on a “share this tip” user interface element (e.g., a button) 324. The information can be stored in memory (e.g., in knowledgebase 29 of FIG. 1) in response to entering the information and selecting a GUI element (e.g., button or the like) 324. Tips that have been entered into the knowledgebase can be reviewed to determine whether the tip should be published. The review can be performed by a leader or other authorized user to screen tips such as to mitigate potential inappropriateness.

In some cases, a tip may not have sufficient information for sharing in the system. If the identity of the user who submitted the tip is known, a message can be sent to request further information. A short message can be sent, for example, via email, text message or other form and provide a link, such as the email message 330 shown in FIG. 12. The message 330 can include a link (e.g., a uniform resource locator) that can open a user-input GUI in which the user can enter information to provide additional information the tip. This information can be sufficient to convert the tip to an idea or to otherwise enable further engagement related to the tip data.

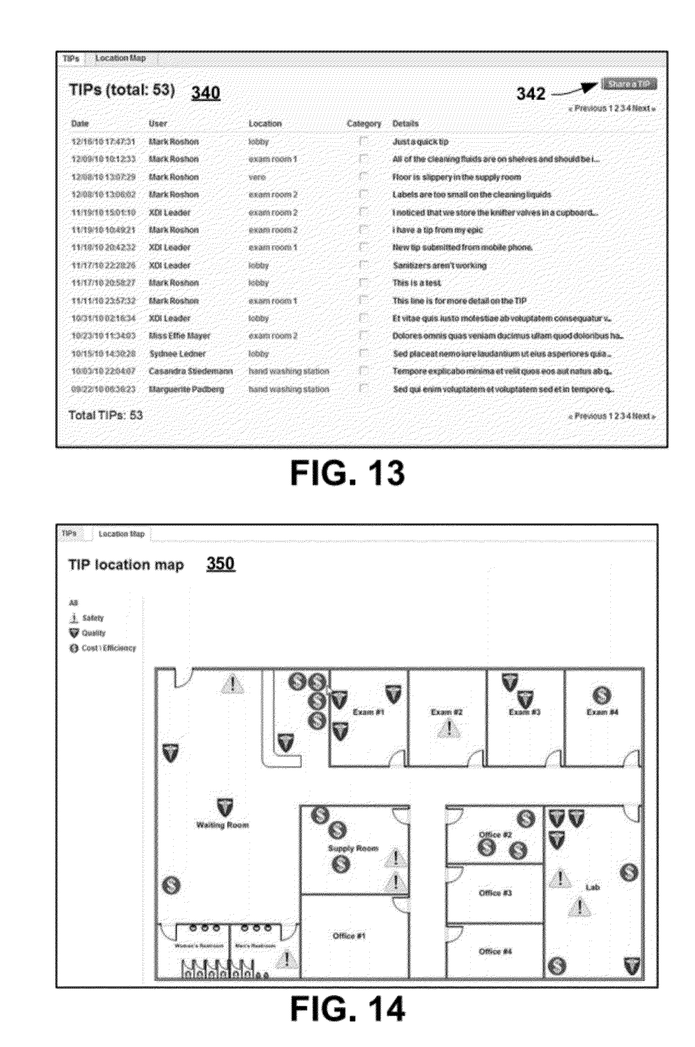

FIG. 13 depicts an example of another tip GUI 340 that can provide a list of tips and related information that can be provided in sortable columns. In the example of FIG. 13, the tip GUI includes a variety of data fields for each tip, such as including an identification user, and location associated with the tip and a description thereof. The user can also enter a new tip via the GUI 340, such as in response to selecting a new tip user interface element 342.

FIG. 14 depicts an example of another tip GUI 350 that can be generated corresponding to a tip location map. In the tip location map GUI 350, locations for each tip can be displayed geospatially associated with a corresponding location where a user had identified the tip. The tip location map GUI 350 can also display a unique icon for each tip that depends on the category of each tip can further be displayed as an icon corresponding to the particular tip category. Each tip icon can operate as an interactive element that can provide further information about a given tip such as in response to selecting it with a curser (e.g., by hovering over the icon or clicking on the icon).

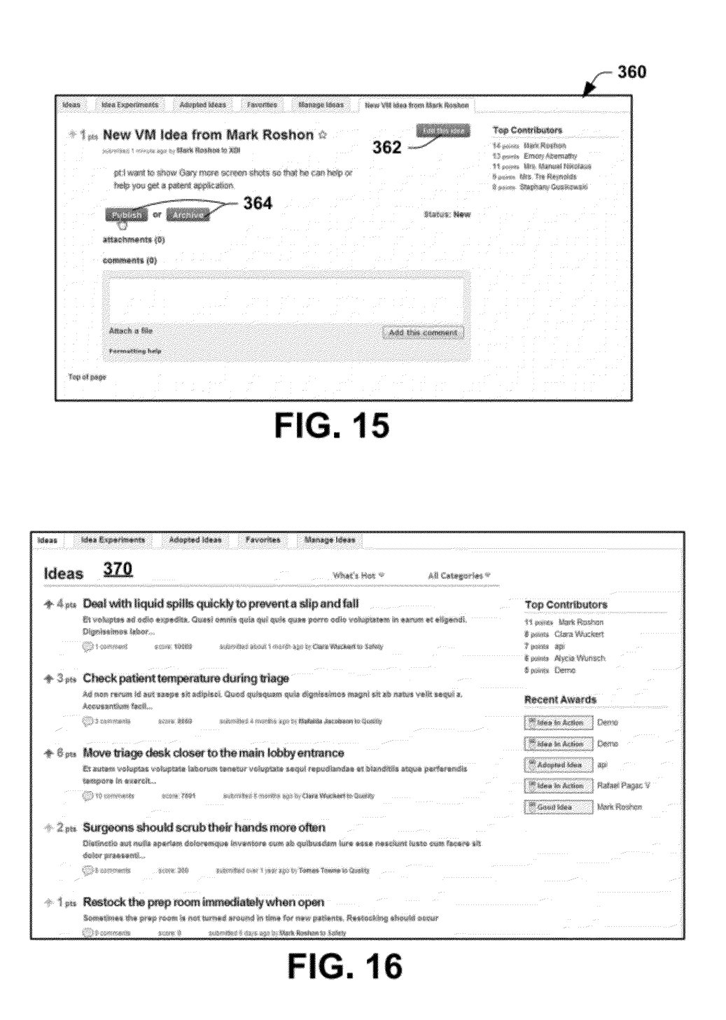

As mentioned above, tips and ideas each can be entered using various forms of communication. For example, FIG. 15 demonstrates an idea GUI corresponding to an idea that had been entered into a predetermined voicemail box assigned to the system. The voicemail box can be accessed by dialing a predefined telephone number. Caller ID can be utilized (e.g., via look-up table of user's telephone number) to ascertain the identity of the user. Automated voice transcription software can be employed to convert the voice message to text. The resulting message can be presented to the user who submitted the idea to edit the message such as via an edit message GUI element 362. The message can also be provided to a leader or other authorized user to control publishing or archiving of the idea via GUI elements 364. One or more files can also be attached to an idea, such as an image (e.g., photo) or other files that might help provide additional information about the idea.

FIG. 16 depicts an example of a GUI 370 that can be utilized to present a listing of active ideas that have been submitted. The GUI 370 can be programmed to sort the ideas according to various criteria, such as can be based on a ranking that is calculated (e.g., by an idea ranking module 40 of FIG. 1). The GUI can provide the set of ideas in an order that is based on the ranking thereof. The calculated score can involve a time-moving average weighting, such that more recent instances of engagement for an idea are afforded a greater weight in the calculations. The ideas listed via the GUI 370 can correspond to duplicate ideas that may have been posted by more than one user. Additionally, in the GUI of FIG. 16, a listing of top contributors of ideas as well as a listing of recent awards can be presented as CPR to further encourage user engagement (e.g., to submit tips, ideas and comments).

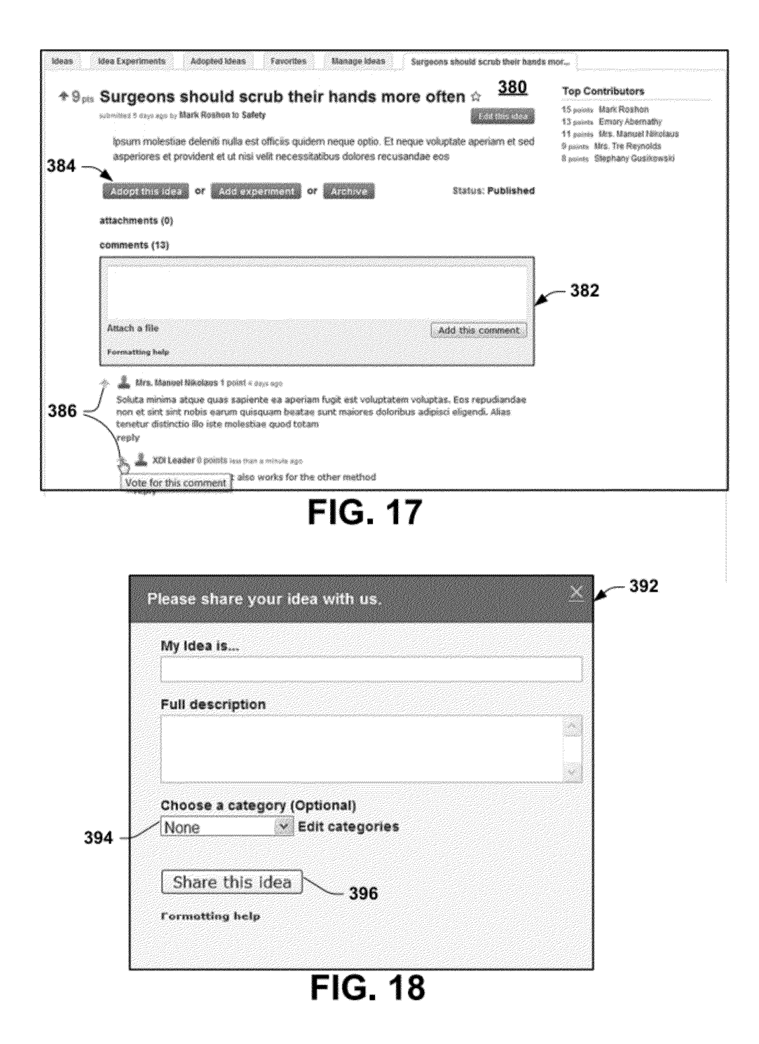

Additional information about a given idea, including comments and notes made in support of or against a given idea can be accessed by double clicking or otherwise selecting a listed idea. The options available for acting on an idea or a comment for an idea can vary depending on the user's role and authorizations within the system. FIG. 17 depicts an example of a GUI 380 for providing details about an active idea (e.g., that surgeons should scrub their hands more often) in the context of a leader or other authorized user that is logged into the system. Thus, in addition to being able to add a comment via corresponding GUI elements 382, the GUI 382 includes GUI elements (e.g., buttons) 384 to change the status of the idea to adopted, add an experiment for the idea or archive it to the knowledgebase. Another aspect of user engagement can be to vote for a comment that has been added to an idea, such as by clicking a GUI element (e.g., an arrow) 386 that is adjacent to a respective comment. A vote thus can increase the score of the underlying idea as well as award points to the user who made the vote (e.g., to reward their engagement) as well as the user who made the comment. Various rules can be established to control automatic awards and allocation of points for different types of user engagement. Online virtual medals can be awarded, for example, based on user participation by sharing ideas, tips providing comments and interacting with the system.

FIG. 18 depicts an example of a “new ideas” GUI 390 that can be provided for creating and sharing a new idea. For instance, the GUI 390 can include a combination of free-form text entry and selectable fields 392 for providing information about the idea, such as a title and a full description of the idea. In the example of FIG. 26, information being solicited via the GUI 390 can include a brief description of what the idea is and additional detailed information about the idea. A user can also specify a category of the idea from a drop down list of predefined categories, demonstrated at 394. Once such information is entered a user can submit the idea. If the idea meets minimum criteria, such as can be determined by another user or via automated means, it may be published for others to view and vote on it. Alternatively, additional information may be requested such as via request engine 24 of FIG. 1. The user can submit the idea via a GUI element (e.g., a button or the like) 396. The data entered can be stored in memory and be available for review to ensure that minimum requirements have been met.

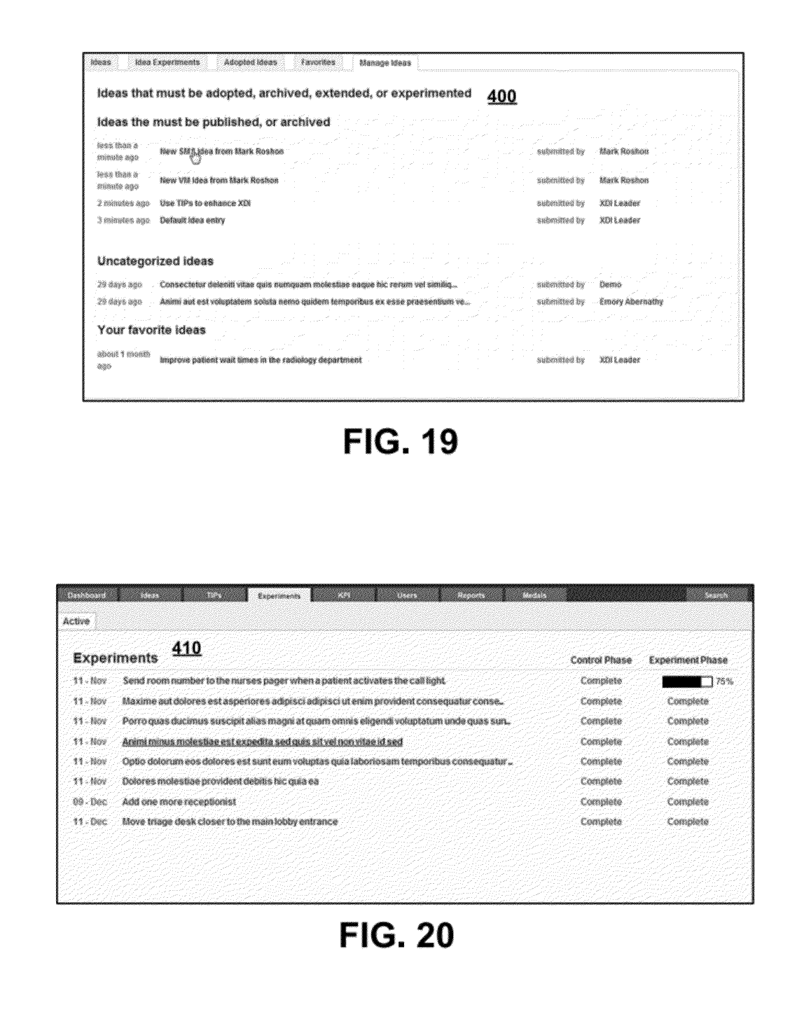

FIG. 19 depicts an example of a “manage ideas” GUI 300 that can be provided to an authorized user. The ‘manage ideas’ GUI 300 can organize the ideas into several lists, such as can vary depending on the status of a given idea. A user thus can select an idea from a corresponding list and change its status, for example, via the GUI 390 of FIG. 18.

FIG. 20 depicts an example of a GUI 410 (e.g., provided by the experiment manager user interface 54 of FIG. 1) that can be utilized for managing experiments. The GUI 410 can include a list of active experiments. For example, the list of active experiments can include an identification of the date of the experiment, a brief description of the experiment, as well as status information, such as whether the control phase and the experiment phase are in progress or have been completed. The status information for example, can include graphical and/or textual information indicating the extent to which each phase has been completed.

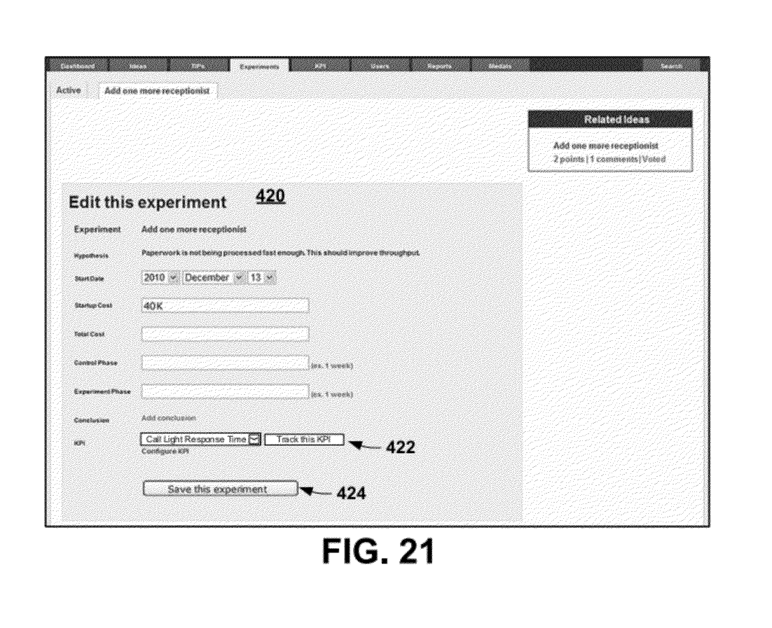

A user can select an experiment from the list provided via the GUI 410 of FIG. 20 to provide additional information about the experiment, such as in a GUI 420 as shown in FIG. 21. In the example of FIG. 21, the experiment is to add one more receptionist. The experiment GUI includes user input elements for entering or editing information about the experiment. The experiment GUI 420 can include a hypothesis field, financial information field, a duration field for the experiment phase as well as specify the duration for a control phase. The GUI 420 can also include a KPI GUI element for setting up each KPI that is part of for a given experiment. In the example of FIG. 21, the information for a KPI can include a GUI element (e.g., a drop down menu of available KPIs) 422 that can be utilized to select a KPI that is to be tracked for the experiment. Various parameters associated with the experiment thus can be edited and saved to the knowledgebase. For example, further KPIs can be added to the experiment or be reconfigured. Once the user is satisfied with the changes to an experiment (if any), a user can save this experiment to the knowledgebase via the corresponding GUI element 424 demonstrated as “save this experiment”. Operating ranges for the KPI can also be set to facilitate providing status information for the KPI being measured (e.g., via dashboard GUI—see FIG. 9).

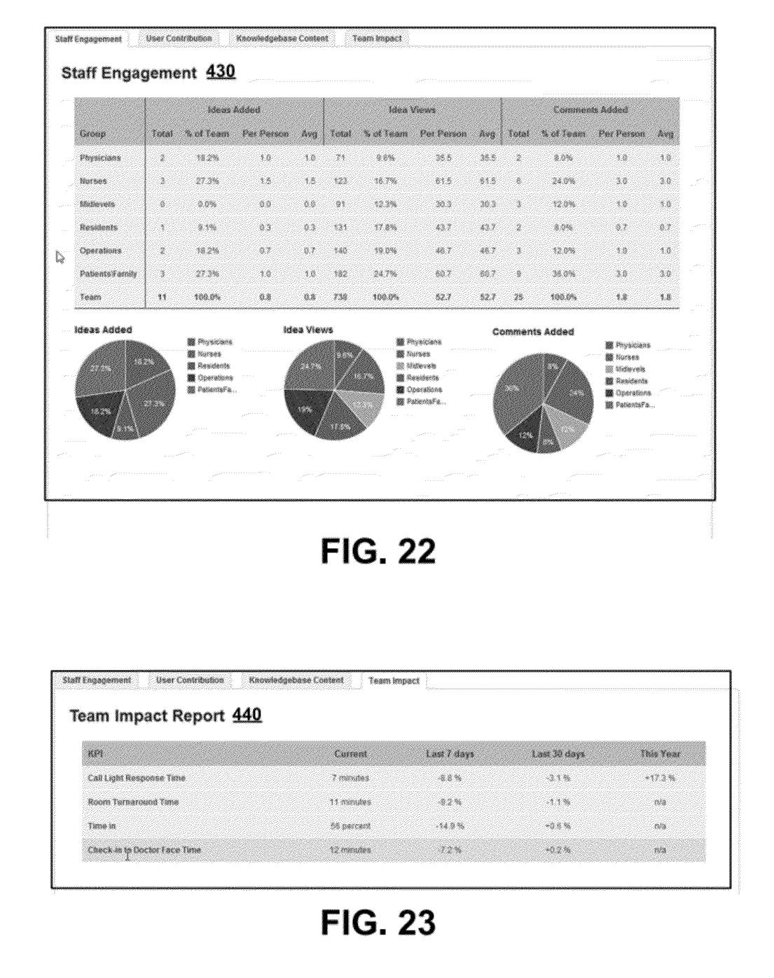

FIGS. 22, 23 and 24 depict examples of report GUIs such as can be generated (e.g., via the reports module 60 of FIG. 1) for providing reports about various phases and activity within the system. FIG. 22 demonstrates an example of a GUI 430 that can provide a report related to staff engagement. In the example of FIG. 22, the staff is identified in respective groups corresponding to a healthcare facility, including physicians, nurses, midlevels, operations, patients/family and totals. Various statistics and related information for ideas added, idea views and comments added can be tracked and displayed in the GUI 430. Graphical representations of engagement data can also be presented (e.g., in pie charts). The information can be interactive, such as to provide additional details in response to a user selecting (e.g., hovering over or clicking on) some of the data with a user input device.

FIG. 23 depicts an example of a GUI 440 showing a team impact report. The impact reporting GUI 440 can be generated for each KPI to demonstrate success and failure associated with KPIs and their associated experiments, such as can be presented as a positive or negative percentage of a goal value for different periods of time. Color coding can also be implemented to indicate whether the percentage is in a desired direction (indicating improvement) or contrary to the desired direction.

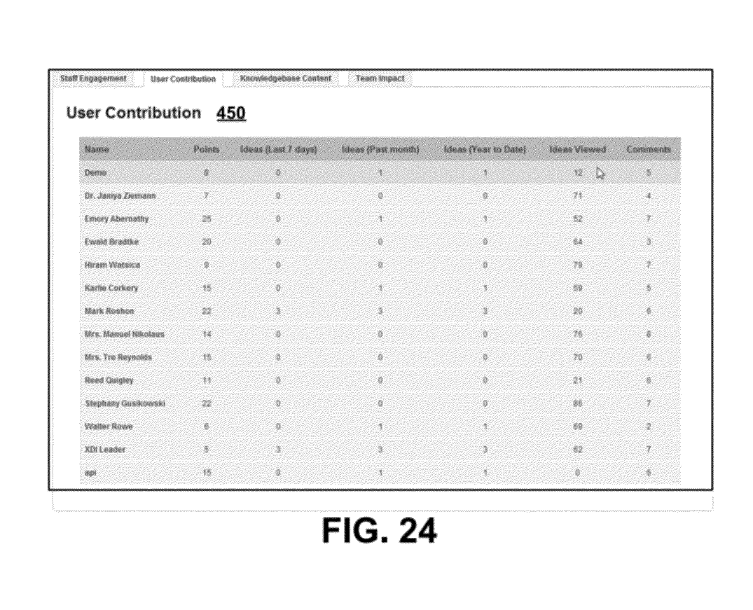

FIG. 24 depicts an example of a report GUI 450 that can present information related to user contributions within the system. As mentioned, points can be awarded to users according to their level of engagement within the system. The user contribution GUI 450 thus can provide a leader or other authorized user an indication of each user's engagement, which can include historical data as well as trending over a period of time.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications and variations that fall within the scope of the appended claims and the application. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.

What is claimed is:

1. A non-transitory computer readable medium programmed to provide an operational-behavioral business intelligence system, comprising:
an idea manager programmed to manage ideas submitted by a user, each idea being stored in a knowledgebase and being capable of validation and conversion into an experiment;
an experiment manager programmed to manage each experiment, including design, execution and analysis thereof, each experiment employing a performance indicator to provide a measure of performance based on behavior probe data captured via a behavior probe, the measure of performance being stored as experiment data for each respective experiment; and
a continuous positive reinforcement (CPR) engine to generate CPR data to provide substantially continuous reinforcement to users based on the data stored in the knowledgebase to drive business processes innovation.

2. The computer readable medium of claim 1, further comprising:
a probe device configured to monitor a predetermined behavior of a user and to communicate a behavior signal indicative of the behavior of the user; and
a data capture module programmed to generate the behavior probe data based on data encoded in the behavior signal.

3. The computer readable medium of claim 2, wherein the behavior probe data comprises information representing at least two of a location of the user, a time, for the a user identity, an indication of movement for the user.

4. The computer readable medium of claim 2, wherein the data encoded in the received signal includes information corresponding to a group type.

5. The computer readable medium of claim 4, wherein the group type is selected from at least a patient and a health care provider.

6. The computer readable medium of claim 2, wherein the data encoded in the received signal is programmed to represent each user anonymously.

7. The computer readable medium of claim 2, wherein is programmed to indicate an identity of the user, the identity of the user is stored in the behavior probe data based on the data encoded in the received signal.

8. The computer readable medium of claim 2, wherein the probe device comprises circuitry configured to send a response signal in response to an interrogation signal that is received by the circuitry, the response signal encoding data identifying the probe device, the experiment manager being programmed to compute a location corresponding to a location of the user.

9. The computer readable medium of claim 8, wherein the circuitry further comprises an RFID device that is moveable relative to a RFID reader, the RFID device transmitting a signal that is received by the RFID reader, the behavior probe data being derived by the experiment manager based on the signal received by the RFID reader.

10. The computer readable medium of claim 8, wherein the circuitry further comprises at least one switch that is activated in response to a user input to provide the interrogation signal, the response signal further comprising data identifying activation of the at least one switch by the user.

11. The computer readable medium of claim 1, wherein the CPR data comprises a time-moving average ranking of each of a plurality of users' engagement with the system.

12. The computer readable medium of claim 11, wherein the CPR engine further comprises a CPR analyzer programmed to quantify engagement of each of a plurality of users separately in relation to each of a plurality of engagement categories.

13. The computer readable medium of claim 12, wherein the engagement categories comprise a quantity of tips submitted by each user, a quantity of ideas submitted by each user and a quantity of comments on the tips or ideas.

14. The computer readable medium of claim 1, further comprising an idea validator programmed to approve a given idea to generate a corresponding experiment, the experiment manager configuring parameters for the corresponding experiment including to measure at least one performance indicator.

15. A method to provide operational-behavioral business intelligence system, comprising:
receiving a tip in response to a user input and storing information related to each of a plurality of tips as tip data in memory;
generating an idea for a process improvement in response to a corresponding user input, the corresponding user input comprising instructions to convert a given tip into the idea or to create a new idea;
storing idea data in the memory related to the generated idea;
creating an experiment to ascertain effectiveness of a selected idea in response to a user input, the experiment including at least one performance indicator operative to provide a measure of a behavioral parameter;
capturing probe data via a behavior probe, the at least one performance indicator being calculated based on the probe data;
storing the probe data and the calculated performance indicator in the memory as experiment data for the respective experiment; and
providing a user interface to provide an indication of each user's engagement with the system in relation to at least one of the tips, the ideas and other interactions with the system.

16. The method of claim 15, further comprising:
calculating a performance metric for the at least one performance indicator; and
generating a display based on the calculated performance metric.

17. The method of claim 15, further comprising:
determining an identity of the user that initiated the given tip or that created the new idea; and
sending a request to the identified user for additional information pertaining to at least the given tip or the new idea.

18. The method of claim 15, further comprising:
computing a score for a plurality of ideas;
ranking the plurality of ideas; and
selecting a given one of the plurality of ideas for creating the experiment.

19. The method of claim 15, wherein the capturing probe data further comprises receiving probe data from a plurality of detectors distributed in a location.

20. The method of claim 15, further comprising quantifying engagement of each of a plurality of users separately in relation to each of a plurality of engagement categories, the quantified engagement comprising a time-moving average ranking of each of a plurality of users' engagement with the system.
